(19) United States
(12) Patent Application Publication
(10) Pub. No.: US 2010/0031760 A1
(43) Pub. Date: Feb. 11, 2010

(54) SYSTEM FOR TRANSFERANCE OF TEST TUBES FROM TUBE RACK TO CENTRIFUGE ROTOR

(76) Inventors: Yury Sherman, Roslindale, MA (US); Michael Sherman, Newton, MA (US); Ian Glasgow, Averill Park, NY (US)

Correspondence Address: K. Gibner Lehmann, 346 Nepas Rd., Fairfield, CT, 06825-2332, US

(21) Appl. No.: 11/773,386

(22) Filed: Jul. 3, 2007

(51) Int. Cl. B01L 9/06; B04B 5/02

(52) U.S. Cl. 73/864.91; 494/20; 422/104

(57) ABSTRACT

The present invention includes a system and method for the management of specimens ordinarily manipulated via tubes. The invention may include a flexible, removable tube holder that is linear when placed in a rack and curved when placed into a centrifuge rotor. The system provides for the elimination of manual recording of the individual tubes, and also provides for the transference of the tubes from the rack to the centrifuge and back in a group.

### BACKGROUND OF THE INVENTION

1. Field of the Invention

The present invention relates generally to the field of scientific research, and more particularly to a system for controlling and maintaining vessels used in scientific research.

2. Description of the Related Art

Scientific research, and more particularly biomedical research, often requires the separation of fractions in complex mixtures by centrifugation. This is a very widespread procedure both in biomedical research and general clinics. Often this procedure is performed with multiple receptacles, such as test tubes. An example of the procedure utilized may be summarized as follows: the tubes are placed in a rack and filled with various solutions and mixtures (generally “media”), for example cell or tissue lysates or similar material that are to be subjected to homogenization, mixing, resuspension, or other treatments; the tubes with media are taken from the rack and manually placed in a centrifuge rotor; next, centrifugation is employed; after centrifugation the tubes are manually taken from the rotor one-by-one, and finally are transferred back to the rack for further storage, testing, treatments and/or recording. These procedures are tedious and often lead to mistakes in placing the tubes in order, eventually leading to errors in experimental results. There is often very little in the way of quality control that is possible for such a method.

Therefore it is clear that there also exists a fundamental problem in the design of tube holders and racks used for holding test vessels. Centrifuge rotors are designed to include a circle shape that allows for placement of vessels in such a way that they are located equidistantly from the center of rotation of the rotor. In contrast, tube holders and racks are typically fashioned in a linear shape to allow for convenient treatment of tubes by an operator. Therefore, the shapes of centrifuge rotors and the racks are incompatible.

What is required is a system that allows for placement of test tubes in a group from a rack to a centrifuge rotor that reduces manual operations and the accompanying errors in testing which are virtually inevitable.

### BRIEF SUMMARY OF THE INVENTION

Therefore, it is an object of the present invention to provide a system that allows for placement of test tubes in a group from a rack to a centrifuge rotor and return them back to the rack after the centrifugation, for storage or subsequent procedures.

The present invention has solved the problems associated with the prior art with the development of a flexible tube holder that can be transferred from a rack to a centrifuge rotor together with test tubes and can be coupled with the rotor and the rack. The tube holder preferably comprises a material, which can be elastically deformed along each of its axes.

According to one embodiment of the present invention, test tubes are placed in distinct vertical openings, one opening for one tube, of the tube holder. The entire holder may then be placed on a rack that may provide for linear or non-linear storage by means of a shoulder that is integral to the holder. The centrifuge may also include a docking mechanism that is also compatible with the shoulder. The docking mechanism then allows for placement of the holder within the centrifuge where centrifugation may take place. After centrifugation the tube holder together with test tubes may be removed from the rotor and placed back onto the rack. Because the arrangement of the tubes is fixed, i.e. the order of adjacent tubes cannot change, one label for the group of tubes will suffice rather than separate labels on each of the 12 or so individual tubes. This saves the user significant effort and time.

According to an alternate embodiment of the present invention, the vertical openings for the test tubes are eliminated and the tubes may be an integral part of the tube holder.

### BRIEF DESCRIPTION OF THE SEVERAL VIEWS OF THE DRAWINGS

These and other features, aspects and advantages of the present invention will become better understood with reference to the following description, appended claims and accompanying drawings where:

FIG. 1 illustrates an isometric view of a tube rack.

FIG. 2 illustrates a fragment of isometric view of a replaceable tube holder.

FIG. 3 illustrates a cross sectional view of a tube holder.

FIG. 4 illustrates an isometric view of the tube holder bent for installation in centrifuge rotor.

FIG. 5 illustrates a cross sectional view of a tube holder filled with the tubes, placed upon the rack.

FIG. 6 illustrates a cross sectional view of the centrifuge rotor with installed tube holder filled with the tubes, ready for centrifugation.

FIG. 7 illustrates a top view of the rotor showing 2 sections for the tube holders.

FIG. 8 illustrates a fragment of isometric view of the second version of a tube holder.

FIG. 9 illustrates a cross sectional view of the centrifuge rotor with installed tube holder of the second version of this invention.

FIG. 10 illustrates a tube holder which relies upon the web between the tube holder rings rather than a separate wall to control the deformed and not-deformed geometric configurations. (isometric view of rings connected by webs).

FIG. 11 illustrates the wall of the web or of the separate wall of the tube holders which encourages the tubes to splay out as the tube holder is bent into an arc. (trapezoidal cross section of wall)

### DETAILED DESCRIPTION OF THE INVENTION

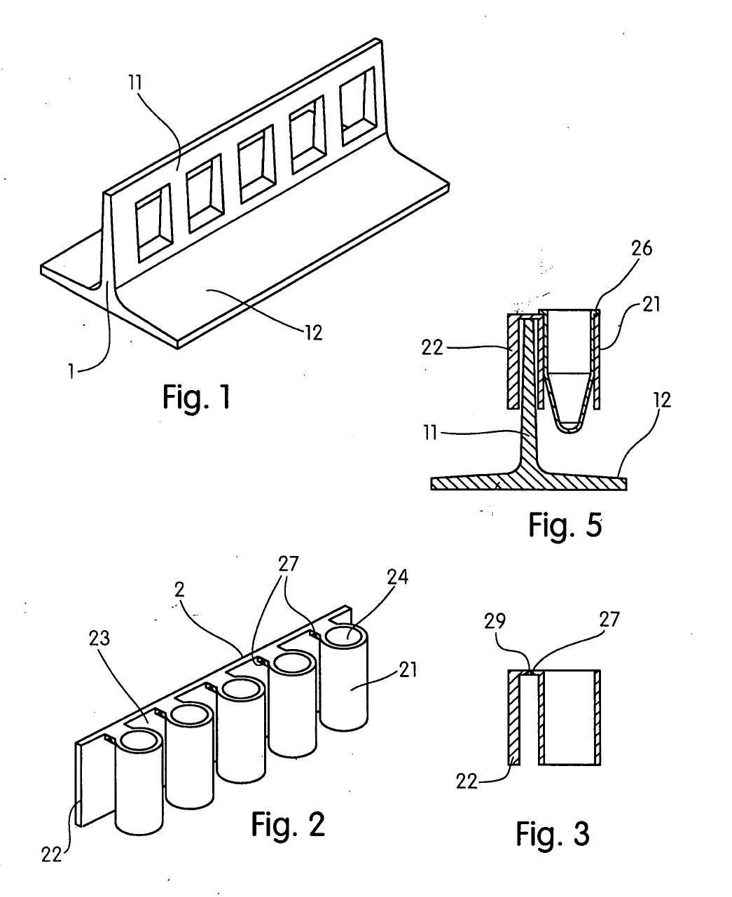

In FIG. 1 rack 1, having substantially linear wall 11 and supporting pad 12 providing stability of the rack, are shown. Thickness and length of wall 11 is suitable for coupling a removable tube holder 2, FIG. 2.

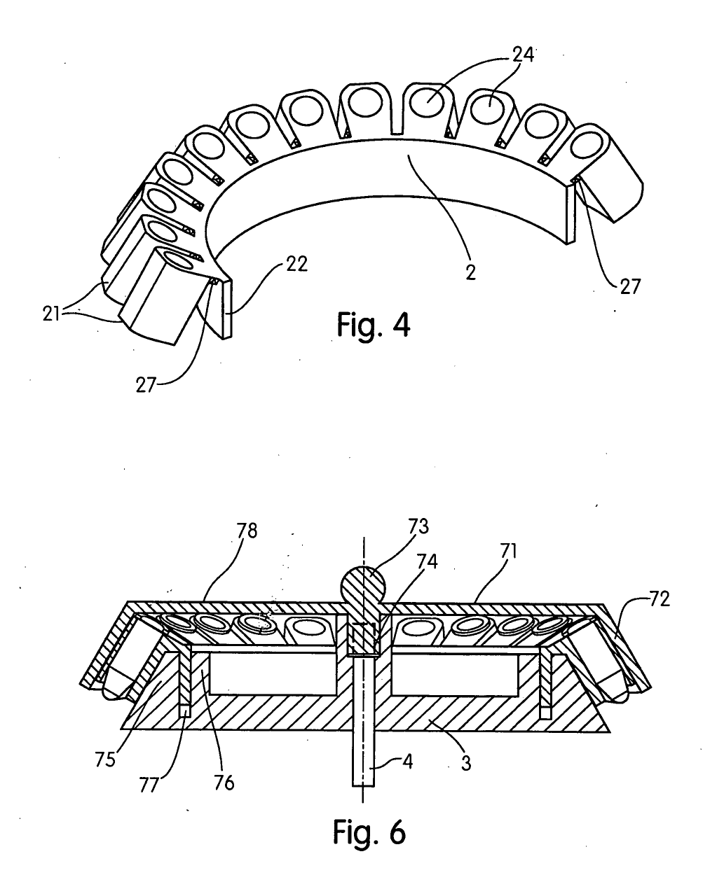

In FIG. 2, a portion of tube holder 2 is shown comprising a plurality of tube cells 21 and shoulder 22. Each tube cell 21 has portions defining an aperture 24 capable of accommodate a test tube. The tube holder 2 also comprises portions defining cell gaps 23 between the pluralities of tube cells 21, which may provide angular displacement of adjacent tube cells 21 when shoulder 22 deformed in an angular manner. Shoulder 22 is integrated with the tube cells 21 by connecting member 29 located at a top portion of the tube holder 2, as shown in FIG. 3. The connecting member 29 includes living hinges 27 along shoulder 22, providing angular displacements of cells 21 about the shoulder. Thus, when the shoulder 22 is bent, cells 21 are able to take a shape shown in FIG. 4 that is suitable for installation of the tube holder 2 into the circular centrifuge rotor

The more elastic the tube holder 2 is, the more easily shoulder 22 may be angularly deformed. However, increase of elasticity decreases the ability of tube holder 2 to restore its linear shape when the holder is removed from a centrifuge rotor to be placed in rack 1, shown in FIG. 1. To balance these controversial features, a flat steel spring can be coupled with shoulder 22 which increases the ability of the shoulder 22 to regain its linear shape.

FIG. 5 shows a cross sectional view of the tube holder 2 with a test tube 26 on a rack 1. As a version of this invention, upper part of wall 11 of the rack contacting with shoulder 22 and cells 21 can be angled at one or both sides of the wall to keep the tubes at the same angle as in the centrifuge rotor.

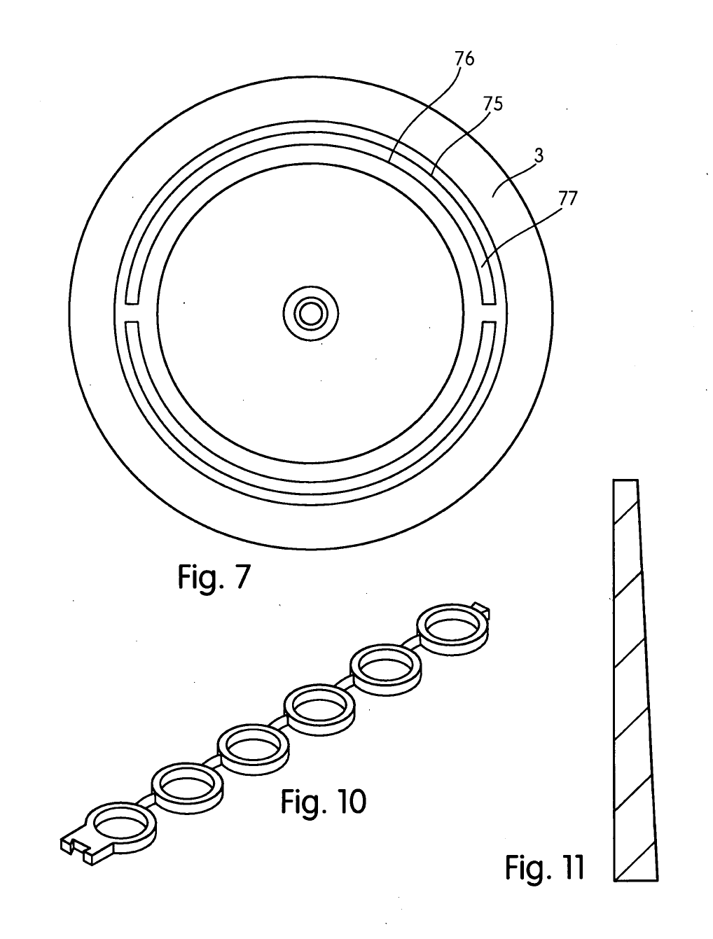

FIGS. 6 and 7 illustrate rotor 3 attached to centrifuge shaft 4 that comprises a structure suitable for accommodation of tube holder 2. The rotor 3 comprises a first vertical circular wall 75 and a second circular wall 76 along the perimeter of the rotor 3, forming slot 77 between them. Slot 77 is capable of accommodating shoulder 22 of tube holder 2. Installation of the tube holder 2 in the rotor 3 is accomplished by insertion of shoulder 22 into slot 77. First circular wall 75 is inclined outside the rotor 3. Due to this, when the tube holder 2 is installed in the rotor 3, tube cells 21, and the test tubes take an inclined position about the rotor 3 that is desirable for optimal centrifugation of the tubes.

In a preferred embodiment of the present invention two holders 2 are employed, each holder 2 containing 12 tubes, and both holders 2 are loaded into rotor 3. Accordingly, slot 77 may be subdivided into two semicircles each of which accommodates one tube holder 2, as is illustrated in FIG. 7. There may be a separating wall between the semicircular slots 77.

To provide stable positioning of tube cells 21 on rotor 3, and in particular to avoid angular displacements of the cells under the applied centrifuge force when rotor 3 is rotated, closure 71 may be used, as shown in FIG. 6. The closure includes top plate 78 attached to the rotor's extension 74, and skirt 72, capable of carrying the centrifuge force. Screw 73 fixes position of closure 78 on rotor 3. Extension 79 along perimeter of the rotor 3 provides additional support to tube cells. 22. Its function is to carry centrifuge force along wall 75, applied to the cells when rotor 3 is rotated.

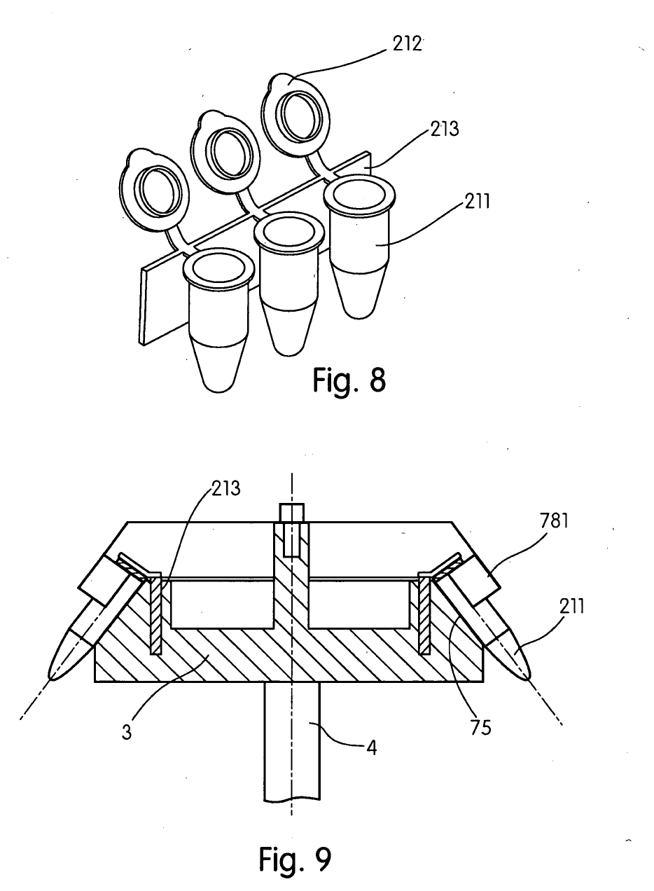

In FIGS. 8 and 9 the second version of the tube holder is shown. Its main difference from the described above is that cells 21 of tube holder 2 are substituted with test tubes 211. Accordingly, the tube holder consists of a tube supporting shoulder 213 integrated with a set of test tubes 211. The major advantages of the second version are manufacturing of test tubes and tube holder as one unit. It eliminates manual marking of the tubes that currently is made by the operator. Extensions 781 from the closure embrace test tubes. They carry centrifuge force along wall 75 of centrifuge rotor, applied to tubes 211 when rotor 3 is rotated and avoid angular displacements of the tubes under the centrifuge force.

In FIGS. 10 and 11 still another version of the invention is shown. FIG. 10 shows a line of rings in which tubes can be placed. The web between the rings acts as a living hinge and controls the bending of this rack into an arc. FIG. 11 shows cross-sectional view of the web in FIG. 10. Note that it is thicker towards the bottom so that as the tube holder is deformed into an arc, the holders tilt such that tubes in them would splay outward, i.e. the tubes would be inclined with the bottoms pointing outward and downward.

The present invention also includes a method for storing, transferring, centrifugation, and/or recording of research vessels. The vessels may comprise microcentrifuge test tubes of 1.5-2 ml volume. The process starts from preparation of test tubes for the centrifugation, including: placing test tubes in tube rack; filling the tubes with media; recording the tubes as desired; transferring the tube holder and tubes in a group to the centrifuge. Then, after centrifugation, the tube holder and tubes are transferred back to the rack for their further storing or treatment.

Although the present invention has been described with reference to particular embodiments, it will be apparent to those skilled in the art that variations and modifications can be substituted therefore without departing from the principles and spirit of the invention.

What is claimed is:

1. A tube holder comprising:
a plurality of tube cells;
portions defining a plurality of cell gaps, wherein said cell gaps are located between said tube cells, providing clearance for angular displacements of said tube cells;
a supportive shoulder, wherein said supportive shoulder is integrated with said tube cells.

2. The tube holder of claim 1, wherein said supportive shoulder further comprises a connecting member, wherein said connecting member associates said supportive shoulder with said tube cells.

3. The tube holder of claim 2, wherein said connecting member further comprises a living hinge, providing angular displacements of said tube cells about said supportive shoulder.

4. The tube holder of claim 3, wherein said tube holder further comprises a flexible material.

5. The tube holder of claim 3, wherein said tube holder further comprises a substantially linear shape.

6. The tube holder of claim 3, wherein said tube holder further comprises a substantially non-linear shape.

7. The tube holder of claim 4, further comprising a stabilizing member, wherein said stabilizing member is integrally located with said supportive shoulder.

8. A tube management system comprising:
a flexible tube holder; and
a tube rack.

9. The tube management system of claim 8, wherein said flexible tube holder further comprises a supportive shoulder, wherein said supportive shoulder unites said flexible tube holder and said tube rack.

10. The tube management system of claim 9 further comprising a rotor, wherein said rotor comprises a tube holder receiving portion.

11. The tube management system of claim 10, wherein said tube holder receiving portion further comprises a substantially circular shape.

12. The tube management system of claim 11, wherein said tube holder receiving portion further comprises a receiving angle, whereby placement of said flexible tube holder in said rotor creates a tube cell angle.

13. The tube management system of claim 12, wherein said rotor further comprises a closure device.

14. A tube holder comprising:
a plurality of test tubes;
portions defining a plurality of tube gaps, wherein said tube gaps are located between said test tubes, wherein said tube gaps provide clearance for angular displacement of said test tubes;
a supportive shoulder, wherein said supportive shoulder is integrated with said test tubes.

15. A method for tube management comprising the steps of:
preparing samples for centrifugation;
placing samples within a flexible tube holder;
securing said tube holder within a centrifuge;
performing centrifugation;
removing said tube holder to a tube rack; and
observing centrifugation results.
